(19) United States
(12) Patent Application Publication
(10) Pub. No.: US 2024/0146458 A1
(43) Pub. Date: May 2, 2024

(54) ELECTRONIC DEVICE AND DATA TRANSMISSION METHOD THEREOF

(71) Applicant: Greater Shine Limited, APIA (WS)

(72) Inventor: JUI-HUI HUNG, HSINCHU CITY (TW)

(21) Appl. No.: 18/051,327

(22) Filed: Oct. 31, 2022

(51) Int. Cl. H04L 1/16; G06F 13/42; H04L 1/00

(52) U.S. Cl. CPC H04L 1/1607; G06F 13/4282; H04L 1/0061

(57) ABSTRACT

The present application provides electronic devices and a data transmission method thereof for UniPro. The electronic device inserts a data length in a first symbol of a frame. Then, the electronic device transmits the first symbol to a peer electronic device and transmits at least one second symbol of the frame to the peer electronic device based on the data length. The peer electronic device receives the first symbol of the frame from the electronic device and receives the at least one second symbol of the frame from the electronic device based on the data length.

### TECHNICAL FIELD

The present disclosure relates to data transmission, and more particularly, an electronic device and a data transmission method thereof for Unified Protocol (UniPro).

### DISCUSSION OF THE BACKGROUND

In some traditional data transmission protocols, for different purposes, encoding technique between different bit formats has been widely developed and applied, such as encoding technique between 8-bit format and 10-bit format, between 64-bit format and 66-bit format or between 128-bit format and 130-bit format. Some of these encoding techniques need additional data or control information to indicate the type of the frame symbol during encoding. However, these encoding techniques between different bit formats may introduce redundant bit consumptions, reducing bus utilization.

This Discussion of the Background section is provided for background information only. The statements in this Discussion of the Background are not an admission that the subject matter disclosed in this Discussion of the Background section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides an electronic device for Unified Protocol (UniPro). The electronic device includes a transmit port and a processor. The processor is electrically coupled to the transmit port and configured to: insert a data length in a first symbol of a frame; transmit, via the transmit port, the first symbol to a receive port of a peer electronic device; and transmit, via the transmit port, at least one second symbol of the frame to the receive port of the peer electronic device based on the data length.

One aspect of the present disclosure provides an electronic device for UniPro. The electronic device includes a receive port and a processor. The processor is electrically coupled to the receive port and configured to: receive, via the receive port, a first symbol of a frame from a transmit port of a peer electronic device; derive a data length in the first symbol; and receive, via the receive port, at least one second symbol of the frame from the transmit port of the peer electronic device based on the data length.

One aspect of the present disclosure provides a data transmission method for UniPro. The data transmission method includes: inserting, by an electronic device, a data length in a first symbol of a frame; transmitting, by the electronic device, the first symbol to a peer electronic device and transmitting, by the electronic device, at least one second symbol of the frame to the peer electronic device based on the data length; and receiving, by the peer electronic device, the first symbol of the frame from the electronic device and receiving the at least one second symbol of the frame from the electronic device based on the data length.

### BRIEF DESCRIPTION OF THE DRAWINGS

A more complete understanding of the present disclosure may be derived by referring to the detailed description and claims. The disclosure should also be understood to be coupled to the figures' reference numbers, which refer to similar elements throughout the description.

FIG. 1A is a block diagram illustrating a data transmission system according to some embodiments of the present disclosure.

FIG. 1B is a schematic diagram of a frame structure according to some embodiments of the present disclosure.

FIG. 2A is a block diagram illustrating a data transmission system according to some embodiments of the present disclosure.

FIG. 2B is a schematic diagram of a frame structure according to some embodiments of the present disclosure.

FIG. 2C is a schematic diagram of a frame structure according to some embodiments of the present disclosure.

FIG. 3 is a flowchart of a data transmission method for UniPro according to some embodiments of the present disclosure.

### DETAILED DESCRIPTION

Embodiments, or examples, of the disclosure illustrated in the drawings are described below using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It will be understood that when an element is referred to as being “connected to” or “coupled to” another element, it may be directly connected to or coupled to the other element, or intervening elements may be present. Moreover, as described herein, the terms “assert”, “asserted”, “assertion”, “de-assert”, “de-asserted” and “de-assertion” will be used to avoid confusion when dealing with a mixture of “active high” and “active low” signals. “Assert”, “asserted” and “assertion” are used to indicate that a signal is rendered active, or logically true. “De-assert”, “de-asserted” and “de-assertion” are used to indicate that a signal is rendered inactive, or logically false.

The terminology used herein is for the purpose of describing particular example embodiments only and is not intended to be limiting to the present inventive concept. As used herein, the singular forms “a,” “an” and “the” are intended to include the plural forms as well, unless the context clearly indicates otherwise. It shall be understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

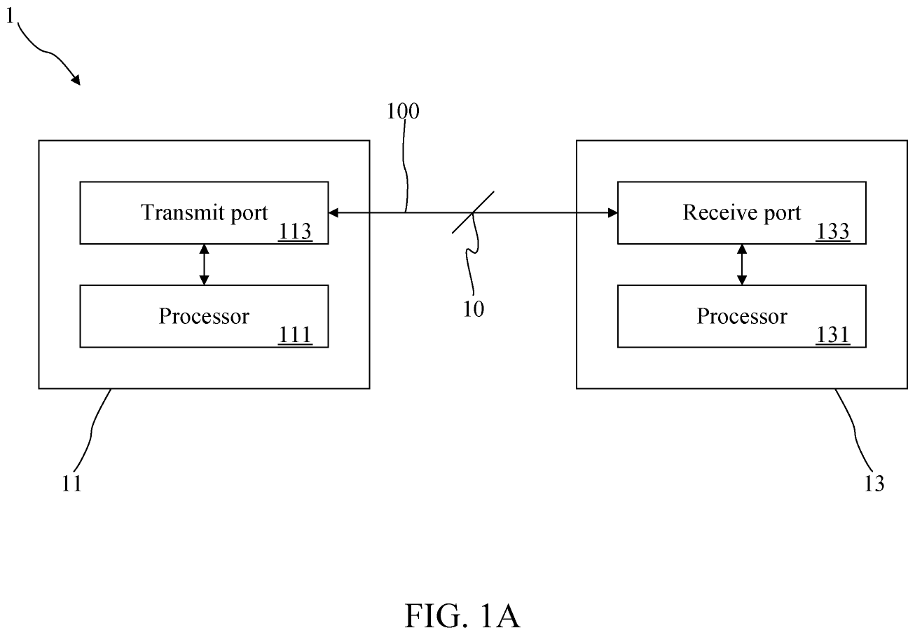

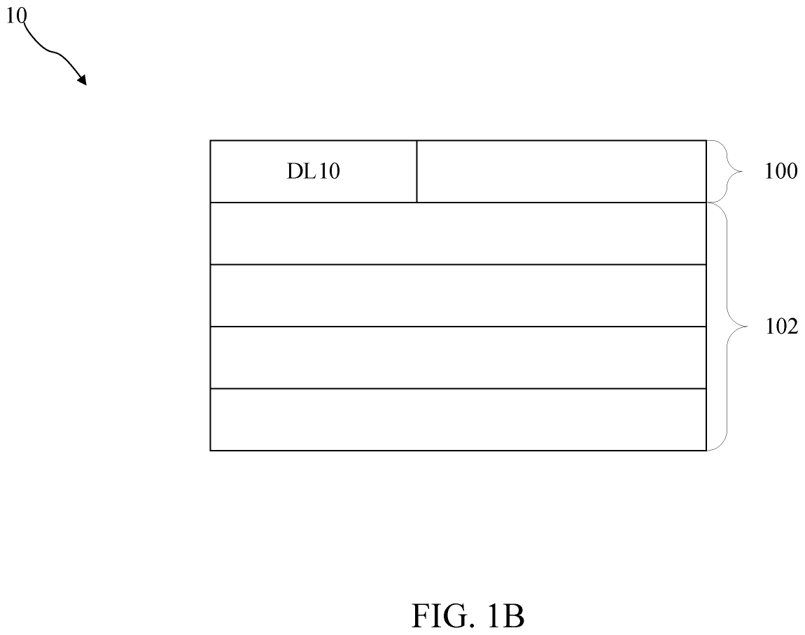

FIG. 1A is a block diagram illustrating a data transmission system 1 according to some embodiments of the present disclosure. The data transmission system 1 includes electronic devices 11 and 13. The electronic device 11 includes a processor 111 and a transmit port 113. The processor 111 is electrically coupled to the transmit port 113. The electronic device 13 includes a processor 131 and a receive port 133. The processor 131 is electrically coupled to the receive port 133. The electronic devices 11 and 13 are compatible with Unified Protocol (UniPro), and data and signals related with UniPro are transmitted between these elements via an electrical connection 100. Related data transmissions are discussed in detail below.

Refer to FIG. 1B together. FIG. 1B is a schematic diagram of a frame structure according to some embodiments of the present disclosure. In particular, a frame 10 is going to be transmitted from the electronic device 11 to the electronic device 13. From the electronic device 11 perspective, before transmitting the frame 10, the processor 111 of the electronic device 11 inserts a data length DL10 in a first symbol 100 of the frame 10. The data length DL10 may be an indication of second symbol(s) 102 following the first symbol 100. The processor 111 of the electronic device 11 transmits, via the transmit port 113, the first symbol 100 to the electronic device 13. Then, the processor 111 of the electronic device 11 transmits, via the transmit port 113, the second symbol(s) 102 to the electronic device 13 based on the data length DL10. Although a specific number of the second symbol(s) 102 is depicted in FIG. 1B, it is contemplated that any number of the second symbol(s) 102 may be arranged in the frame 10.

From the electronic device 13 perspective, the processor 131 of the electronic device 13 first receives, via the receive port 133, the first symbol 100 of the frame 10. The processor 131 is operable to derive the data length DL10 in the first symbol 100, which reports the number of second symbol(s) 102 following the first symbol 100. Then, the processor 131 of the electronic device 13 receives, via the receive port 133, the second symbol(s) 102 based on the data length DL10.

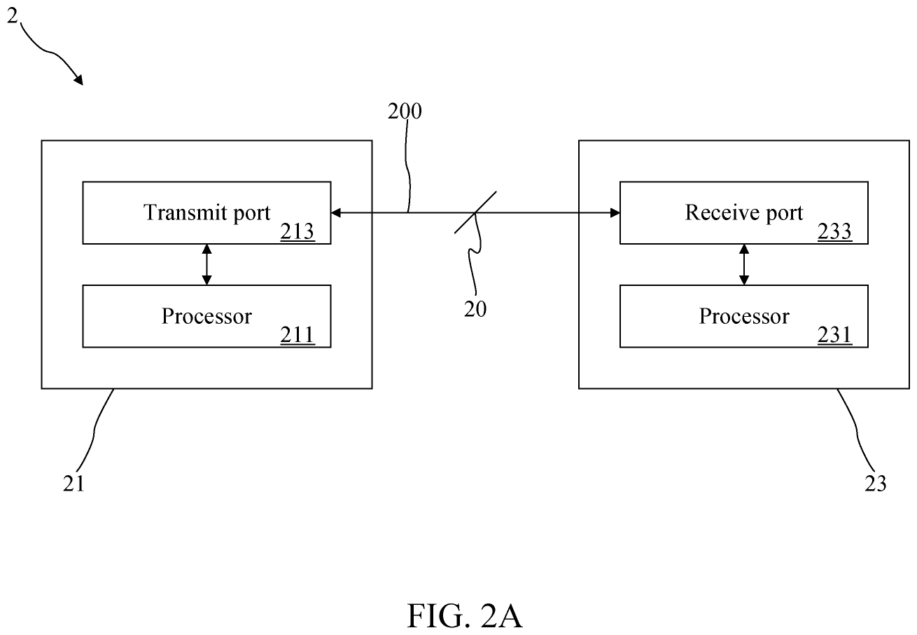

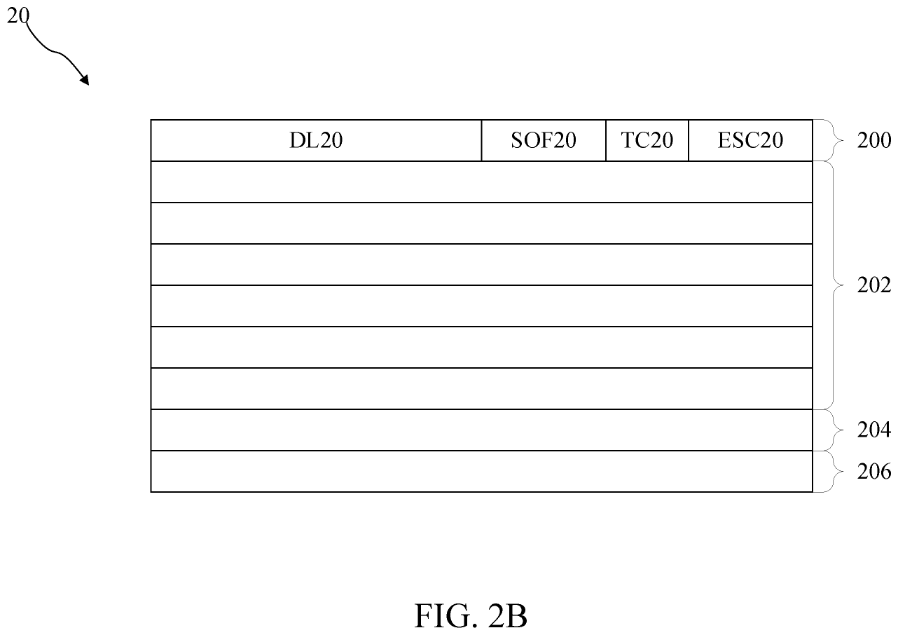

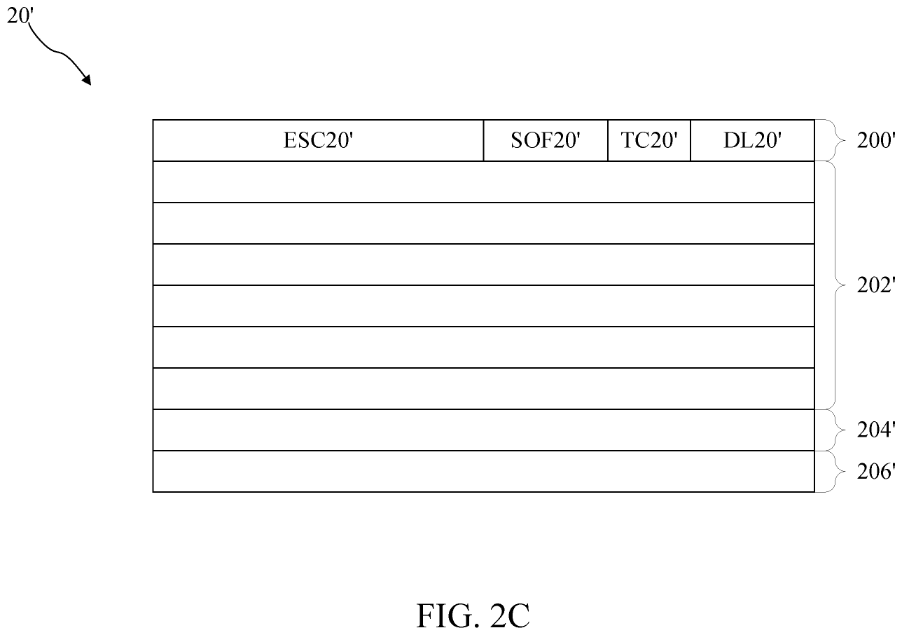

FIG. 2A is a block diagram illustrating a data transmission system 2 according to some embodiments of the present disclosure. The data transmission system 2 includes electronic devices 21 and 23. The electronic device 21 includes a processor 211 and a transmit port 213. The processor 211 is electrically coupled to the transmit port 213. The electronic device 23 includes a processor 231 and a receive port 233. The processor 231 is electrically coupled to the receive port 233. The electronic devices 21 and 23 are compatible with UniPro, and data and signals related with UniPro are transmitted between these elements via an electrical connection 200. Related data transmissions are discussed in detail below.

Refer to FIG. 2B together. FIG. 2B is a schematic diagram of frame structure according to some embodiments of the present disclosure. In particular, a frame 20 is going to be transmitted from the electronic device 21 to the electronic device 23 without bit encoding, such as 8b/10b encoding that maps 8-bit words to 10-bit symbols.

The frame 20 is a data frame compatible with UniPro and includes a plurality of symbols. Each symbol is fixed in length, which is 16 bits long for example. As shown in FIG. 2B, the first symbol 200 is a control symbol (i.e., start of frame (SOF) control symbol) including fields of: (1) a data length DL20 having 8 bits; (2) a SOF indicator SOF20 having 3 bits; (3) a traffic class TC20 having 2 bits; and (4) an escape character ESC20 having 3 bits. Each of the second symbol(s) 202 following the first symbol 200 is a data symbol. The third symbol 204 subsequent to the last second symbol 202 is a control symbol (i.e., end of frame (EOF) control symbol). The fourth symbol 206 following the third symbol 204 is a cyclic redundancy check (CRC) symbol of the frame 20. Although a specific number of the second symbol(s) 202 is depicted in FIG. 2B, it is contemplated that any number of the second symbol(s) 202 may be arranged in the frame 20.

In some embodiments, the field of the data length DL20 indicates a total number of the data symbol(s) (second symbol(s) 202) in the frame 20. The field of the SOF indicator SOF20 indicates the start of the frame 20. The field of the traffic class TC20 indicates the traffic class of the frame 20. The field of the escape character ESC20 is a layer header.

In accordance with some embodiments of the first symbol 200, the first field, where the data length DL20 is located, is specified for the escape character field of a UniPro control symbol, and the last field, where the escape character ESC20 is located, is specified for the reserved field of the UniPro control symbol. In other words, compared with a standard UniPro control symbol including a first field specified for an escape character and a last field specified for reserved bits, the first field of the control symbol 200 is specified for the data length DL20, the last field of the control symbol 200 is specified for the escape character ESC20, and the other fields (i.e., SOF field and TC field) of the control symbol 200 remain the same as these fields of the UniPro control symbol.

From the electronic device 21 perspective, before transmitting the frame 20, the processor 211 of the electronic device 21 determines that there is (are) the data symbol(s) (second symbol(s) 202) following the first symbol 200, and determines the total number of the data symbols conveyed in the frame 20. The processor 211 of the electronic device 21 then inserts the data length DL20, which indicates the quantity of the data symbols to be transmitted, in the first symbol 200. The processor 211 of the electronic device 21 transmits, via the transmit port 213, the first symbol 200 to the electronic device 23. Then, the processor 211 of the electronic device 21 transmits, via the transmit port 213, the data symbol(s) (second symbol(s) 202) to the electronic device 23 based on the data length DL20. After transmitting the second symbol(s) 202, the processor 211 of the electronic device 21 transmits, via the transmit port 213, the third symbol 204 and the fourth symbol 206 to the electronic device 23.

From the electronic device 23 perspective, the processor 231 of the electronic device 23 first receives, via the receive port 233, the first symbol 200 of the frame 20. The processor 231 is operable to derive the data length DL20 in the first symbol 200, which reports the total number of the data symbol(s) (second symbol(s) 202) following the first symbol 200. Then, the processor 231 of the electronic device 23 receives, via the receive port 233, the data symbol(s) (second symbol 202) based on the data length DL20. After receiving the second symbol(s) 202, the processor 231 of the electronic device 23 receives, via the receive port 233, the third symbol 204 and the fourth symbol 206.

It should be note that the third symbol 204 (i.e., the EOF control symbol) and the fourth symbol 206 (i.e., the CRC symbol) may be regular symbols compatible with UniPro. Therefore, after receiving all the data symbols based on the data length DL20, the electronic device 23 can be aware of the arrival of the last two symbols 204 and 206 to finish the receipt of the frame 20. In addition, any filler symbol may not be inserted between the data symbol and the CRC symbol.

For example, in a scenario that there are five second symbols 202 following the first symbol 200 of the frame 20, the processor 211 of the electronic device 21 inserts the data length of ‘0b101’ in the first symbol 200 to indicate five second symbols 202 to be transmitted after the first symbol 200. The processor 211 of the electronic device 21 transmits, via the transmit port 213, the first symbol 200 to the electronic device 23. Then, the processor 211 of the electronic device 21 transmits, via the transmit port 213, five second symbols 202 to the electronic device 23. After transmitting the five second symbols 202, the processor 211 of the electronic device 21 transmits, via the transmit port 213, the third symbol 204 and the fourth symbol 206 to the electronic device 23.

The processor 231 of the electronic device 23 first receives, via the receive port 233, the first symbol 200 of the frame 20. The processor 231 derives the data length of ‘0b101’ and is thus aware that there are five second symbols 202 following the first symbol 200. Then, the processor 231 of the electronic device 23 receives, via the receive port 233, the five second symbols 202. After receiving the five second symbols 202, the processor 231 of the electronic device 23 receives, via the receive port 233, the third symbol 204 and the fourth symbol 206 to finish the receipt of the frame 20.

In some embodiments, the size and the position of the data length DL20 in the first symbol 200 may be adjusted. For example, please refer to FIG. 2C which is a schematic diagram of another frame structure according to some embodiments of the present disclosure. In particular, a frame 20′ is going to be transmitted from the electronic device 21 to the electronic device 23 without bit encoding, such as 8b/10b encoding that maps 8-bit words to 10-bit symbols.

The frame 20′ is a data frame and includes a plurality of symbols. Each symbol has 16 bits in length. The first symbol 200′ is a control symbol (i.e., a SOF control symbol) including fields of: (1) an escape character ESC20′ having 8 bits; (2) a SOF indicator SOF20′ having 3 bits; (3) a traffic class TC20′ having 2 bits; and (4) a data length DL20′ having 3 bits. Each of the second symbol(s) 202′ following the first symbol 200′ is a data symbol. The third symbol 204′ subsequent to the last second symbol 202′ is a control symbol (i.e., an EOF control symbol). The fourth symbol 206′ following the third symbol 204′ is a CRC symbol of the frame 20′. Although a specific number of the second symbol(s) 202′ is depicted in FIG. 1B, it is contemplated that any number of the second symbol(s) 202′ may be arranged in the frame 20′.

It should be noted that the first symbol 200′ is configured to place the data length DL20′ in its last field that is specified for the reserved field of a UniPro control symbol. In other words, compared with a standard UniPro control symbol including a last field specified for reserved bits, the last field of the control symbol 200′ is specified for the data length DL20′ and the other fields (i.e., ESC field, SOF field, and TC field) of the control symbol 200′ remain the same as these fields of the UniPro control symbol.

In some embodiments, because the symbols 200, 202, 204 and 206 (or the symbols 200′, 202′, 204′ and 206′) are transmitted without bit encoding, the symbols 200, 202, 204, and 206 (or the symbols 200′, 202′, 204′ and 206′) are transmitted without adding any extra bit indicating what type (e.g., control or data) of a symbol is being transmitted, and the symbols 200, 202, 204 and 206 (or the symbols 200′, 202′, 204′ and 206′) are received without any extra bit indicating what type (e.g., control or data) of a symbol is being received.

According to some embodiments of the present disclosure, the first symbol 200 (or the first symbol 200′) and the second symbol(s) 202 (or the second symbol(s) 202′) are scrambled by the processor 211 of the electronic device 21 without any extra bit in a physical layer (i.e., M-PHY) before transmission, and the first symbol 200 (or the first symbol 200′) and the second symbol(s) 202 (or the second symbol(s) 202′) are descrambled by the processor 213 of the electronic device 23 without any extra bit in the physical layer.

It should be understood that the electronic devices described in the foregoing embodiments can be universal flash storage (UFS) compatible devices utilizing UniPro or modems utilizing UniPro. The processors described in the foregoing embodiments can be a central processing unit (CPU), other hardware circuitry components capable of executing related instructions, or a combination of computing circuitry generally known to a person skilled in the art on the basis of the disclosure above. The transmit port or the receive port described in the foregoing embodiments can include a transmission interface (e.g., I/O interface, transceiver, etc.) for transmitting data between electronic devices; however, such description is not to be construed as limitations to the embodiments of hardware implementation scenarios of the present invention.

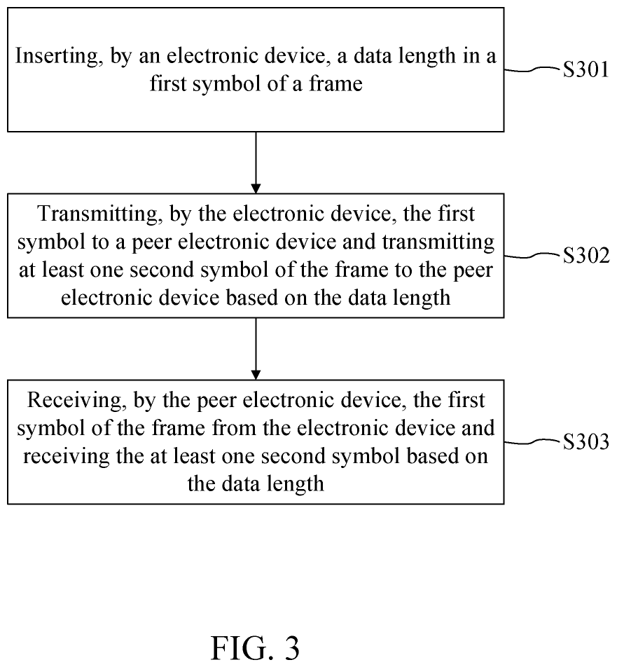

Some embodiments of the present disclosure include a data transmission method for UniPro, the flow chart of which is shown in FIG. 3. The data transmission method of these embodiments is implemented by electronic devices (such as the electronic devices of the previous embodiment), and the details of the method are as follows.

Step S301 is executed to insert, by an electronic device, a data length in a first symbol of a frame. Step 302 is executed to transmit, by the electronic device, the first symbol to a peer electronic device and transmit, by the electronic device, at least one second symbol of the frame to the peer electronic device based on the data length. Step S303 is executed to receive, by the peer electronic device, the first symbol of the frame from the electronic device and receive one or more second symbols of the frame from the electronic device based on the data length.

In some embodiments, the data length indicates a total number of the second symbols conveyed in the frame. In some embodiments, the frame includes a data frame compatible with UniPro. The first symbol is a UniPro control symbol and the second symbol is a data symbol. The UniPro control symbol includes: (1) a first field specified for an escape character field of a UniPro control symbol; (2) a second field indicating a start of the frame; and (3) a last field specified for a reserved field. In some embodiments, the data length is placed in the first field and an escape character is packed into the last field.

In some embodiments, the control symbol and the data symbol are transmitted and received without an extra bit indicating what type of symbol is conveyed in the frame. In some embodiments, the first symbol and the second symbol(s) are scrambled without the extra bit in a physical layer before transmission.

In conclusion, based on the data length inserted by an electronic device in the control symbol of a frame, a peer electronic device receiving the control symbol can obtain the exact number of the data symbol(s) following the control symbol. Accordingly, the electronic devices and data transmission method of the present disclosure can transport the frame without bit encoding so that the bus utilization may reach 100%. Further, the electronic devices and data transmission method of the present disclosure can transmit and receive the frame without an additional bit indicating the type (e.g., control or data) of the symbol conveyed in the frame. The same throughput with fewer lanes and/or lower operating frequency can be achieved, which leads to low power consumption and fewer cost in the hardware area.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An electronic device for Unified Protocol (UniPro), comprising:
a transmit port; and
a processor, being electrically coupled to the transmit port and configured to:
insert a data length in a first symbol of a frame;
transmit, via the transmit port, the first symbol to a receive port of a peer electronic device; and
transmit, via the transmit port, at least one second symbol of the frame to the receive port of the peer electronic device based on the data length.

2. The electronic device of claim 1, wherein the data length indicates a total number of the at least one second symbol to be transmitted in the frame.

3. The electronic device of claim 2, wherein the at least one second symbol includes at least one data symbol.

4. The electronic device of claim 3, wherein the first symbol includes a control symbol, the data length is placed in a first field of the control symbol, an escape character is packed into a last field of the control symbol, the first field of the control symbol is specified for an escape character field of a UniPro control symbol and the last field of the control symbol is specified for a reserved field of the UniPro control symbol.

5. The electronic device of claim 4, wherein the control symbol includes a second field (SOF) specified in the Unified Protocol which indicates a start of the frame.

6. The electronic device of claim 4, wherein the processor is further configured to transmit the control symbol and the at least one data symbol without adding an extra bit indicating what type of symbol is being transmitted.

7. The electronic device of claim 6, wherein the processor is further configured to scramble the first symbol and the at least one second symbol without the extra bit in a physical layer before transmission.

8. An electronic device for Unified Protocol (UniPro), comprising:
a receive port; and
a processor, being electrically coupled to the receive port and configured to:
receive, via the receive port, a first symbol of a frame from a transmit port of a peer electronic device;
derive a data length in the first symbol; and
receive, via the receive port, at least one second symbol of the frame from the transmit port of the peer electronic device based on the data length.

9. The electronic device of claim 8, wherein the data length indicates a total number of the at least one second symbol to be received in the frame.

10. The electronic device of claim 9, wherein the at least one second symbol includes at least one data symbol.

11. The electronic device of claim 10, wherein the first symbol includes a control symbol, the data length is placed in a first field of the control symbol, an escape character is packed into a last field of the control symbol, the first field of the control symbol is specified for an escape character field of a UniPro control symbol and the last field of the control symbol is specified for a reserved field of the UniPro control symbol.

12. The electronic device of claim 11, wherein the control symbol includes a second field (SOF) specified in the Unified Protocol which indicates a start of the frame.

13. The electronic device of claim 11, wherein the processor is further configured to receive the control symbol and the at least one data symbol without an extra bit indicating what type of symbol is being received.

14. The electronic device of claim 13, wherein the processor is further configured to descramble the first symbol and the at least one second symbol without the extra bit in a physical layer.

15. A data transmission method for Unified Protocol (UniPro), comprising:
inserting, by an electronic device, a data length in a first symbol of a frame;
transmitting, by the electronic device, the first symbol to a peer electronic device and transmitting, by the electronic device, at least one second symbol of the frame to the peer electronic device based on the data length; and
receiving, by the peer electronic device, the first symbol of the frame from the electronic device and receiving the at least one second symbol of the frame from the electronic device based on the data length.

16. The data transmission method of claim 15, wherein the data length indicates a total number of the at least one second symbol conveyed in the frame.

17. The data transmission method of claim 16, wherein the first symbol includes a control symbol and the at least one second symbol includes at least one data symbol.

18. The data transmission method of claim 17, wherein the control symbol includes:
a first field specified for an escape character field of a UniPro control symbol;
a second field indicating a start of the frame; and
a last field specified for a reserved field of the UniPro control symbol;
wherein the data length is placed in the first field and an escape character is packed into the last field.

19. The data transmission method of claim 17, wherein the control symbol and the at least one data symbol are transmitted and received without an extra bit indicating what type of symbol is conveyed in the frame.

20. The data transmission method of claim 19, wherein the first symbol and the at least one second symbol are scrambled without the extra bit in a physical layer before transmission.
